(19) United States
(12) Patent Application Publication
(10) Pub. No.: US 2007/0171339 A1
(43) Pub. Date: Jul. 26, 2007

(54) Array substrate for liquid crystal display and manufacturing method thereof

(75) Inventors: Mu-Jen Su, Tainan City (TW); Ching-Huan Lin, Hsinying (TW); Te-Sheng Chen, Chupei (TW); Chih-Ming Chang, Chungli (TW)

Correspondence Address: BIRCH STEWART KOLASCH & BIRCH, PO BOX 747, FALLS CHURCH, VA, 22040-0747, US

(73) Assignee: AU Optronics Corp.

(21) Appl. No.: 11/336,963

(22) Filed: Jan. 23, 2006

(51) Int. Cl. G02F 1/1335

(52) U.S. Cl. 349/114

(57) ABSTRACT

An LCD substrate is used to prevent polyimide from unevenly distributing during heat and leveling processes. A portion of dielectric layers on data lines in transmissive regions is removed to form channels, which penetrate the dielectric layers between two adjacent transmissive regions. In other words, dielectric layer has a second thickness corresponding to the channels. Polyimide is distributed to all of transmissive regions evenly via these channels. There is a wall having a fifth thickness between a transmissive region and accordingly neighboring with reflective region to prevent polyimide distributing from the reflective region to the transmissive region because of the different thickness of the dielectric layer in the transmissive regions and the reflective regions. Thereof polyimide distributes evenly among transmissive regions and reflective regions to form a uniform alignment film because of these channels and walls. Then the alignment of the liquid crystal molecules is absolutely controlled to improve and maintain the quality of LCD.

### BACKGROUND OF THE INVENTION

1. Field of the Invention

The present invention generally relates to an array substrate for liquid crystal display and manufacturing method thereof, and more particularly relates to a liquid display structure and method for forming the same.

2. Description of the Related Art

In a liquid crystal display, for controlling the tilting direction of the liquid crystal, it is necessary to provide a pre-tilt angle to change the polarizing direction of the light. By this pre-tilt angle, the displaying function of the liquid crystal display is accomplished. Therefore, liquid crystal alignment layer, polyimide layer for example, is used in order to provide the pre-tilt angle for applying liquid crystal tilting direction. After the controlling electric field disappearing, the liquid crystal molecules are still regularly arranged according to a special direction. And the high contrast and the stability of the image are maintained by the arrangement.

Presently, in most of liquid crystal display, no matter what kind of liquid crystal display, polyimide is used as the material to form the photo-alignment layer, in which the liquid crystal molecules are arranged in the same direction and angle, by the relief printing and rubbing. The anchoring energy between the liquid crystal molecules and the boundary, the angle of the pre-tilt angle and the rotating direction of liquid crystal molecules are controlled by the photo-alignment layer.

In a liquid crystal display, polyimide is transferring printed to each pixel of the liquid crystal display by the eminent structure of the APR. The quality of the photo-alignment layer is decided by the design of the eminent structure of the APR and the rate of the transferring printing. However the size and the arrangement of the eminent structure of the APR are restricted by the number of the mesh of the APR. Therefore, the number of the mesh of the APR directly affect the quality of the photo-alignment layer, and the size of the pixels of the liquid crystal display also affects the quality of the photo-alignment layer. The relation between the pixels and the eminent structures of the APR is showed in FIG. 1. FIG. 1 is a plane diagram in top view of the liquid crystal display 100, and the circle 102 stands for the region in which polyimide is transferring printed.

Generally, a roller is used to form the photo-alignment layer with the polyimide. The situation of transferring printing the polyimide is controlled by the rotational speed of the roller, the downward pressure of the roller, and the speed of delivering the glass. Polyimide is a precursor which is composed of diacid anhydride and diamine. Although the recipe of the rotational speed of the roller, the downward pressure of the roller, and the speed of delivering the glass can be obtained by keeping trying and error, but the rate of transferring printing the polyimide are still not 100%. Referring to FIG. 1, the polyimide is not transferring printed on each of the pixels which is defined by the data lines and scan lines, for example there is no polyimide to be transferring printed on the region 104 except the edge of the region 104 and there is no polyimide to be transferring printed on the region 106. After polyimide is transferring printed, polyimide is evenly distributed to each of regions of the pixels by the leveling process in order to control liquid crystal. Then after a heating process, the polyimide is solidified. But even after the leveling process and the heating process, there is just a little or no polyimide in the partial transferring printed region 104 and the non-transferring printed region 106. It is because of the protruding structure on the panel, such as the data lines between the adjacent transmissive regions or between the adjacent pixels, or it is because of some structures which has level drop, such as the level drop structure between the transmissive region and the reflective region. Therefore, the polyimide can not be evenly distributed to each region of the panel, and it is bad for controlling and arranging the liquid crystal molecules. And the quality of the image of the liquid crystal display gets worse.

The foregoing problems of unevenly distributing of the polyimide will happen in all kind of the liquid crystal display no matter transmissive liquid crystal display, reflective liquid crystal display, or transflective liquid crystal display. Particularly, the problems of the transflective liquid crystal display gets worse. It is because of the pixels of the transreflective liquid crystal display are divided into transmissive regions and reflective regions. There are two kinds of structure of the transflective liquid crystal display. One is single cell gap and another is dual cell gap. For the dual cell gap structure of the transflective liquid crystal display, the height of reflective region is twice of the height of the transmissive region. Therefore, in the leveling process, the polyimide in the reflective regions falls downward to the transmissive regions because of the different height between the transmissive regions and the reflective regions and gravity, and the polyimide is got together in the transmissive regions. So there is almost no polyimide in the reflective regions, and the arrangement of the liquid crystal molecules is got worse.

### SUMMARY OF THE INVENTION

In view of foregoing description, the transferring printed liquid crystal alignment layer, polyimide layer or other photo-alignment layer, for example, cannot be evenly distributed on the substrate after the leveling process and the hot process because of the protruding structure and the level dropping structure. One object of the present invention is to provide an array substrate to solve the unevenly distributed polyimide caused by the protruding structure on the array substrate. This object is accomplished by removing all or part of the dielectric layers of some data lines. The gray scale mask process is used to form the dielectric layer with two kinds of thickness on the data lines. In other words, the protruding structure on the array substrate is removed to form a channel of the adjacent transmissive regions or the adjacent pixels. The polyimide can be distributed to all transmissive regions to solve the problem that the liquid crystal molecules are out of control because of the uneven photo-alignment layer.

Another object of the present invention is to provide a method of solving the problem of unevenly distributing of the polyimide, which is caused by the level dropping structures. The level dropping structure is between the transmissive region and the reflective region, and the most of the polyimide is gathered on the lower regions (transmissive regions) because of the gravity and the different height between the transmissive region and the reflective region. A raised structure is forming between the transmissive region and the reflective region to be used as the wall in order to prevent the unevenly distributing of the polyimide. And an even photo-alignment layer can be formed on the substrate to control the arrangement of the liquid crystal molecules. The wall can be disposed in the reflective region, and the raised part of the lumpy surface of the reflective layer is used as the wall. But the wall can be disposed in the transmissive region, and a raised structure on the boundary of the transmissive region is formed as the wall by changing the mask in the dielectric layer forming process.

According to the foregoing objects, an array substrate is provided in one embodiment of the present invention. The array substrate comprises a base in which a plurality of the data lines and scan lines are disposed. And the pixels are defined on the base by the data lines and scan lines. A dielectric layer is disposed on the base to cover parts of the data lines. There are two kinds of thickness of the dielectric layer on the data line between adjacent pixels. One is the first thickness and another is the second thickness. The first thickness is larger than the second thickness, and a channel is formed between adjacent pixels by the different thickness of the dielectric layer on the data line. The polyimide can be distributed to all transmissive regions evenly by the channels. In the present invention, a plurality of the channels can be formed in one pixel. There are a transmissive region and a reflective region in each pixel. The dielectric layer has the third thickness in the transmissive region and has the fourth thickness in the reflective region. A reflective layer having the sixth thickness is disposed on the reflective layer. And the dielectric layer on the boundary between the transmissive region and the reflective region has the fifth thickness. The fifth thickness is equal to or larger than the sum of the fourth thickness and the sixth thickness. Therefore, the dielectric layer having fifth thickness is used as a wall to prevent the polyimide in reflective regions from floating into the transmissive regions by the level dropping structure and the gravity.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a cross-sectional diagram illustrating the distribution of polyimide of the conventional liquid crystal display panel;

FIG. 2A is plane diagram illustrating a liquid crystal display in which part of the dielectric layer on the data lines of the transmissive region in accordance with one embodiment of the present invention, and FIG. 2B to 2E are cross-section diagrams illustrating the structure of different region of the liquid crystal display shown in FIG. 2A;

FIG. 3A to 3C are plane and cross-section diagrams illustrating a liquid crystal display in which there is a wall between the transmissive region and reflective region in accordance with another embodiment of the present invention, and

FIG. 3B to 3C are cross-section diagrams illustrating the structure of different region of the liquid crystal display showed in FIG. 3A;

FIG. 4A to 4B are plane and cross-section diagrams illustrating a liquid crystal display in which part of the dielectric layer are on the data lines of the transmissive region, and there is a wall between the transmissive region and reflective region in accordance with another embodiment of the present invention, and FIG. 4B is a cross-section diagram illustrating the structure of the liquid crystal display shown in FIG. 3A;

FIG. 5 is a plane diagram illustrating a liquid crystal display in which the transmissive regions and reflective regions are arranged face to face in accordance with further another embodiment of the present invention;

FIG. 6 is a plane diagram illustrating a liquid crystal display in which the transmissive regions and reflective regions are arranged with S-type in accordance with further another embodiment of the present invention;

FIG. 7 is a plane diagram illustrating a liquid crystal display in which the transmissive region is encircled by the reflective region in accordance with further another embodiment of the present invention;

FIG. 8 is a plane diagram illustrating a liquid crystal display in which the three sides of the transmissive region are encircled by the reflective region in accordance with further another embodiment of the present invention;

FIG. 9 is a plane diagram illustrating a liquid crystal display in which the reflective region is encircled by the transmissive region in accordance with further another embodiment of the present invention;

FIG. 10 is a plane diagram illustrating a liquid crystal display in which the three sides of the reflective region are encircled by the transmissive region in accordance with further another embodiment of the present invention;

FIG. 11 is a plane diagram illustrating a liquid crystal display in which the transmissive region and the reflective region are interlocked and arranged in accordance with further another embodiment of the present invention; and

FIG. 12 is a plane diagram illustrating a liquid crystal display in which one unit comprising three transmissive regions and another unit comprising three reflective regions are interlocked and arranged in accordance with further another embodiment of the present invention.

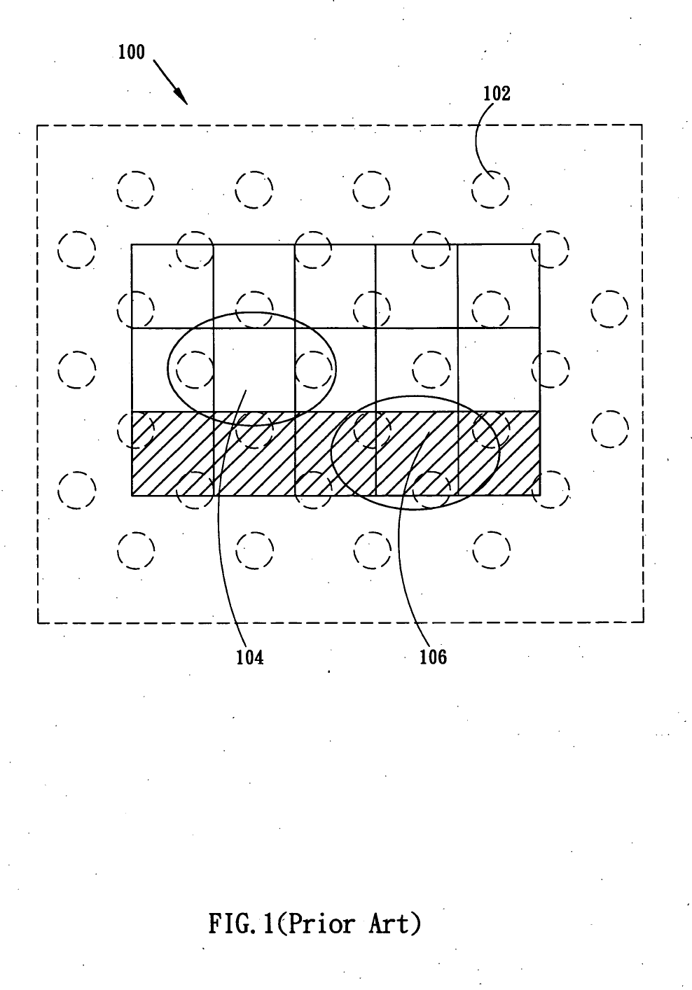

### DESCRIPTION OF THE PREFERRED EMBODIMENT

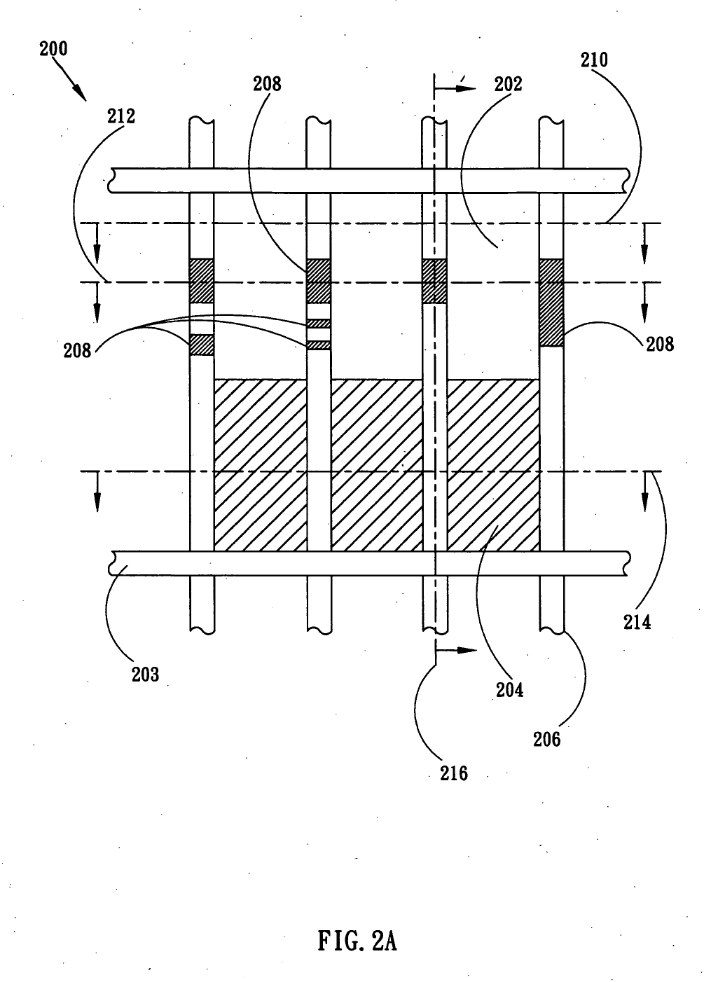

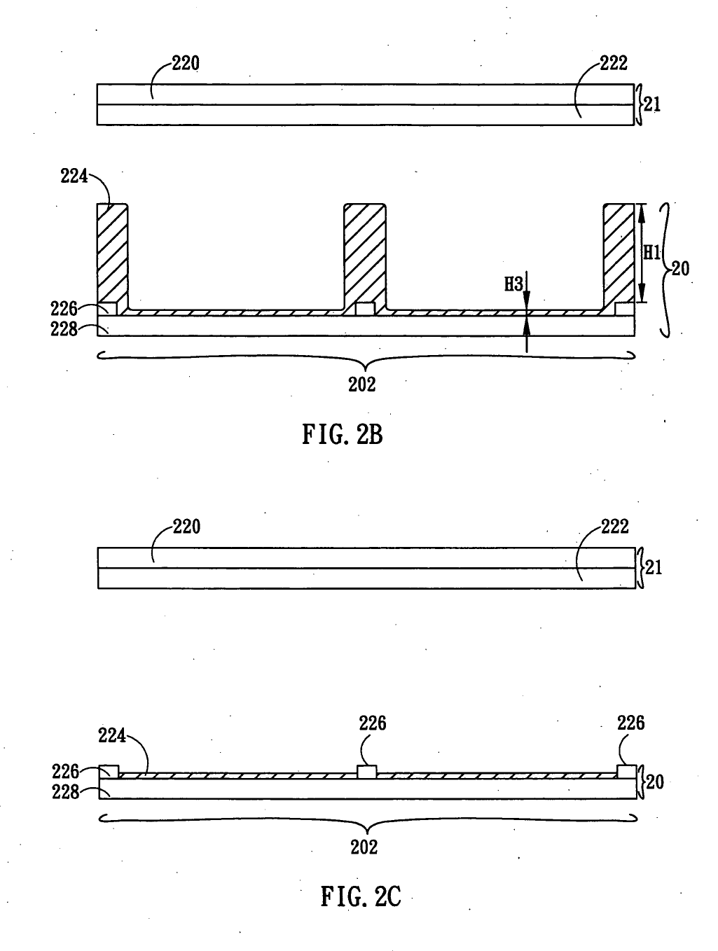

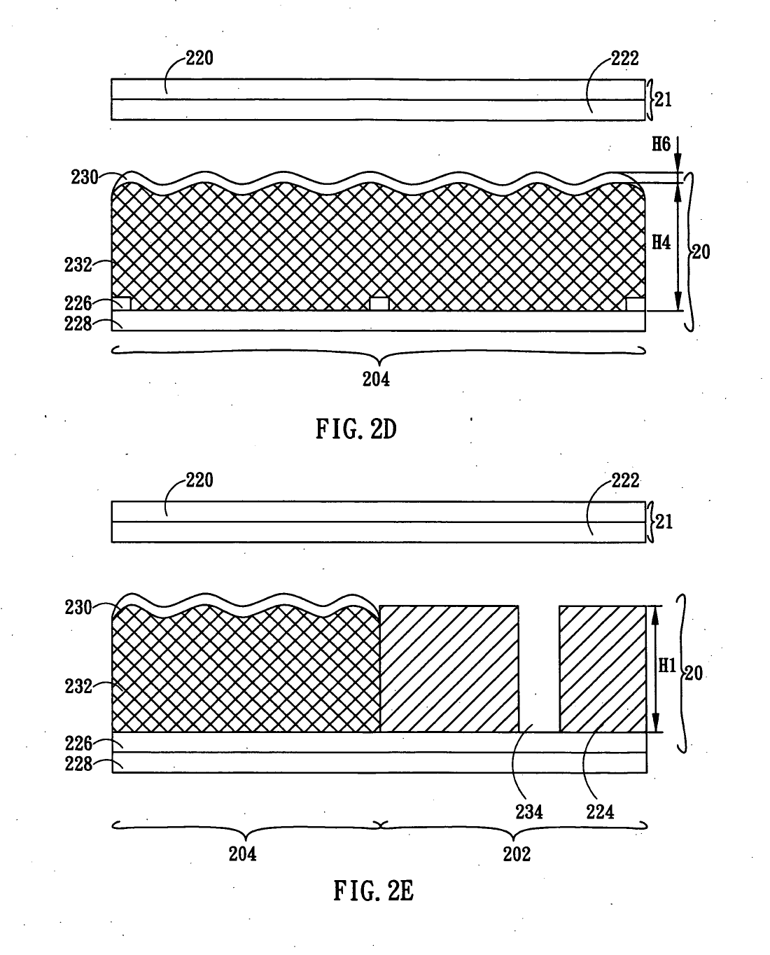

Referring to FIG. 2A, it is a plane diagram of a lower substrate (or array substrate) 200 of liquid crystal panel in accordance with one preferred embodiment of the present invention. A plurality of pixels on the lower substrate (or array substrate) 200 are defined by a plurality of data lines 206 and scan lines 203. In the embodiment, the lower substrate 200 comprises one or a plurality of transmissive regions 202 and reflective regions 204. Each transmissive region 202 is connected with the reflective region 204 by one side. A dielectric layer is disposed on the lower substrate 200, the data lines 206 and the scan lines 203. Part of the dielectric layer on the data lines 206 is removed by gray scale mask process or half-tone mask process, for example. So there are two kinds of the thickness of the dielectric layer on the data lines 206 and channels 208 are formed by the different thickness of the dielectric layer on the data lines 206. The thickness of the dielectric layer on the bottom of the channel 208 is equal to or smaller than 3 μm (micrometer), but not limited. In another embodiment, the thickness of the dielectric layer on the bottom of the channel 208 is between 1.5 μm (micrometer) and 2.5 μm (micrometer), and it means that the dielectric layer on the bottom of the channel 208 is not removed completely. But even the bottom of the channel 208 is not completely removed, the thickness of the dielectric layer of the non-channel region is thicker than the thickness of the dielectric layer of the channel 208. In the embodiment of the present invention, the dielectric layer in the channel 208 is completely removed, and there are a plurality of channels 208 in each of the pixels. In the spirit of the present invention, the size and the length of the channels 208 can be changed optionally, and the present invention is not limited thereto. After the polyimide is transferring printed on the substrate 200 and the leveling process is proceed, the polyimide can be distributed to each transmissive regions by these channels 208, even the regions on which the polyimide is partly transferring printed or is completely not transferring printed. Therefore, the polyimide is solidified and reacted by heating process, and then the alignment layer (photo-alignment layer, for example) is formed evenly. The photo-alignment layer formed by the way is even on the substrate and the liquid crystal molecules can be absolutely controlled to arrange evenly. So the quality of liquid crystal display can be controlled because of the even photo-alignment layer. The following FIG. 2B, FIG. 2C, FIG. 2D and FIG. 2E are the cross-section of the lower substrate (or array substrate) 200 of the liquid crystal panel illustrating in FIG. 2A, and an upper substrate 21 is provided thereof. FIG. 2B, FIG. 2c, FIG. 2D and FIG. 2E are the cross-section diagrams of the lower substrate 200 of the liquid crystal panel illustrating in FIG. 2A along the dotted lines 210, 212, 214, and 216.

FIG. 2B is the cross-section view of the lower substrate (or array substrate) 200 and an upper substrate structure 21 of the liquid crystal panel of FIG. 2A along the dotted line 210. The dotted line 210 crosses several transmissive regions 202, several data lines 206 and the regions in which the dielectric layer of the data lines is not removed. Referring to FIG. 2B, it comprises a lower substrate structure 20 (or an array substrate structure) and an upper substrate structure 21 corresponding to the lower substrate structure 20. In the embodiment, the upper substrate structure 21 comprises an upper substrate 220 and a color filter 222 facing the lower substrate structure 20 (or array substrate structure). There are several blocks (not show) on the surface of the color filter 222 facing the lower substrate structure 20. The upper substrate structure 21 also can be used in the MVA liquid crystal display. The lower substrate structure 20 (or an array substrate structure) comprises a lower base 228 and several data lines 226 formed thereon. The lower base 228 and the data lines 226 are covered by a dielectric layer 224. The dielectric layer 224 on the lower base 228 has the first thickness, and the dielectric layer 224 on the data lines 226 has the third thickness. The dielectric layer 224 on the data lines 226 is higher than the dielectric layer 224 on the lower base 228 because the data lines 226 are disposed on the lower base 228 and are under the dielectric layer 224. So the height of the dielectric layer 224 on the data lines 226 is different from the height of the dielectric layer 224 on the lower substrate 228. The distribution of the polyimide is limited in following process because of the different height of the dielectric layer 224 on the data lines 226 and on the lower substrate 228. And the polyimide is difficult to distributed to the adjacent transmissive regions evenly. Besides, there can be a passivation layer (not shown) between the dielectric layer 224 and the lower substrate 228.

FIG. 2C is the cross-section view showing the lower substrate (or array substrate) 200 and an upper substrate structure 21 of the liquid crystal panel of FIG. 2A along the dotted line 212. The dotted line 212 crosses several transmissive regions, several data lines 206 and the regions in which the dielectric layer of the data lines is removed. In the regions, the dielectric layer 224 has the second thickness. In the embodiment, the second thickness is zero, and it means that the dielectric layer in the region is completely removed to form the channels 208. The channels 208 cross the adjacent transmissive regions 202. Referring to FIG. 2C, it is different from FIG. 2B, and the difference between the FIG. 2B and FIG. 2C is that there is no dielectric layer 224 on the data line 206 or the thickness of the dielectric layer 224 on the data line is smaller than the first thickness H1. Therefore, the different height between the dielectric layer 224 on the data lines 226 and on the lower base 228 is smaller. There are some channels 208 formed by the way and the polyimide can be distributed to the adjacent transmissive regions 202 evenly by the channel 208. The photo-alignment layer can be formed evenly in the transmissive regions.

FIG. 2D is the cross-section view showing the lower substrate (or array substrate) 200 an upper substrate structure 21 of the liquid crystal panel of FIG. 2A along the dotted line 214. The dotted line 214 crosses several reflective regions 204 and several data lines 206. Referring to FIG. 2D, the lower base 228 and the data line 226n are covered by a dielectric layer 232 having the fourth thickness H4. A lumpy surface is formed on the surface of the dielectric layer 232 by at least one exposure process and the development process. Then a reflective material is coated on the dielectric layer 232 to form a reflective layer 230. The reflective material can be metal, such as a aluminum material, a sliver material and etc. The reflective layer 230 has the sixth thickness H6 and it means the thickness from the top surface of the dielectric layer 232 to the top surface of the reflective layer 230. Besides, there can be a passivation layer (not shown) between the lower base 228 and the dielectric layer 232.

FIG. 2E is the cross-section view showing the lower substrate (or array substrate) 200 and an upper substrate structure 21 of the liquid crystal panel of FIG. 2A along the dotted line 216. The dotted line 216 crossing the transmissive regions 202 and the reflective region 204 is on a data line 226. Referring to FIG. 2E, in the transmissive region 202, there is a region in which the dielectric layer 224 on the data line 226 is removed to form a channel 234. The dielectric layer 224 on the data line 226 in the region has a second thickness. In the embodiment, there is no any dielectric layer 224 on the bottom of the channel 234 and it means that the dielectric layer 224 on the bottom of the channel 234 is completely removed. In other words, the second thickness is zero. However, in other embodiment of the present invention, the dielectric layer 224 on the bottom of the channel 234 is not removed completely. The dielectric layer 224 on the bottom of the channel 234 is partly removed and there is a thinner dielectric layer 224 which has the second thickness on the bottom of the channel 234. The second thickness is smaller than the first thickness, and the second thickness is equal to or smaller than 3 μm (micrometer). The first thickness H1 is also equal to or smaller than 3 μm (micrometer) but it is necessary that the first thickness must be larger than the second thickness for the forming of the channel 234. So the polyimide can be distributed to each of transmissive regions 202 evenly by the channel 234. In the present invention, the largest range of the region 234 in which the dielectric layer 224 on the data line 226 is removed can be as long as the data line 226. The sum of the thickness of the dielectric layer 232 disposed on the lower base 228 and on the data lines 226, and the thickness of the reflective layer 230 in the reflective region 204 is larger than that of the dielectric layer 224 in the transmissive region 202. So there is a level-dropping structure on the boundary of the transmissive region 202 and the reflective region 204. Besides, there can be a passivation layer (not shown) between the lower base 228 and the dielectric layer 232. In the present invention, there can be one channel 234 or a plurality of the channels 234. In spirit of the present invention, the size and the length of the channels are not limited.

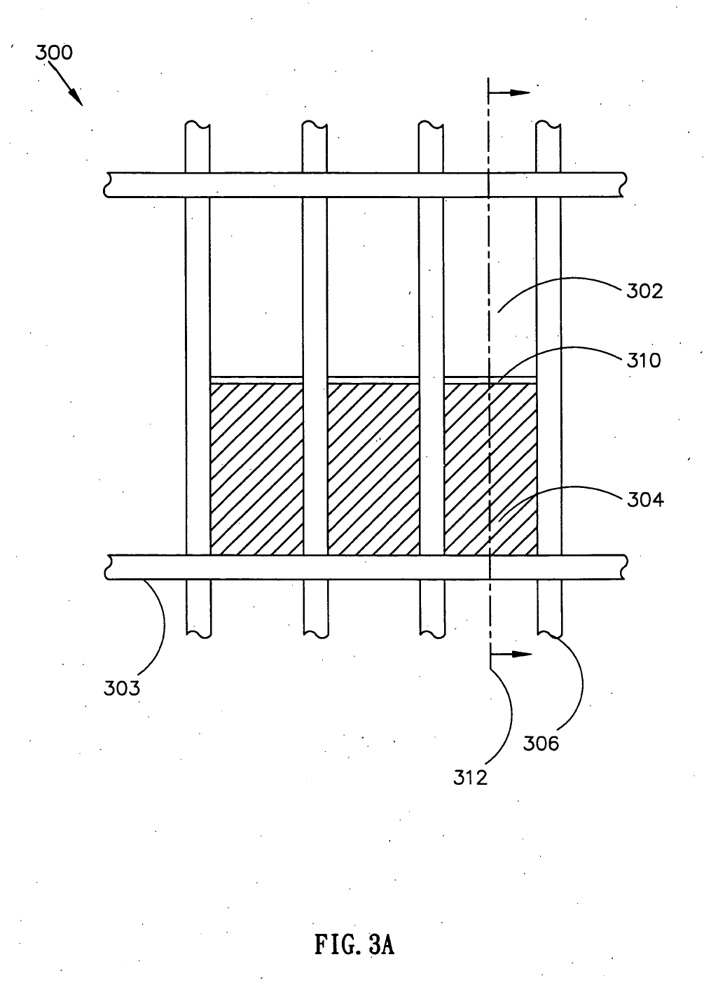

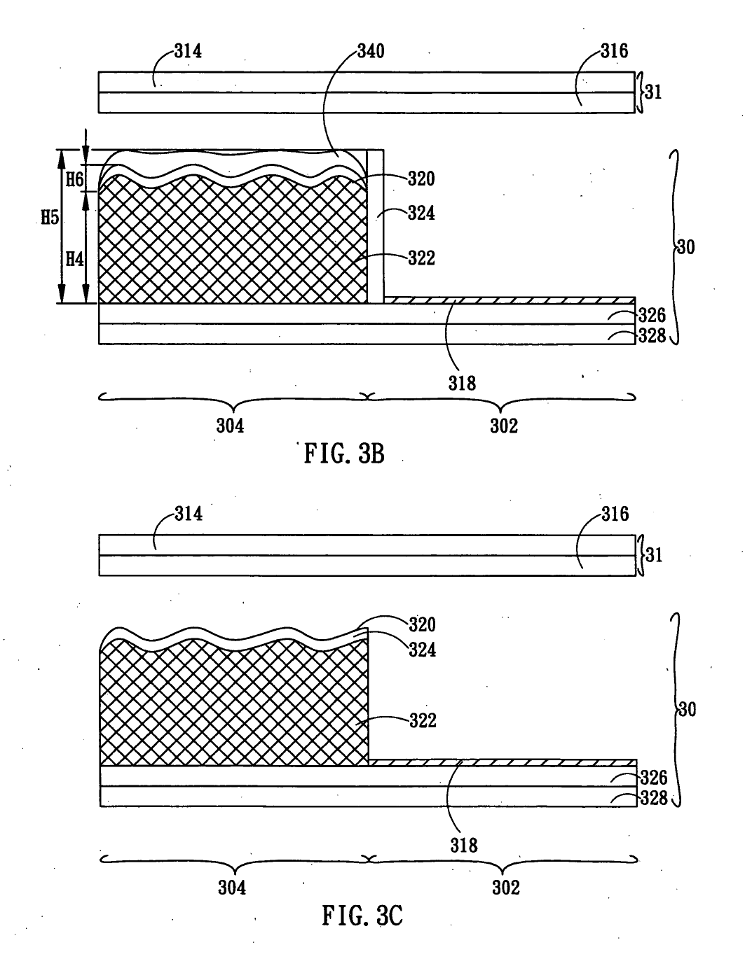

Referring to FIG. 3A, it is a plane diagram of a lower substrate (or array substrate) 300 of the liquid crystal panel in accordance with another embodiment of the present invention. A plurality of pixels on the lower substrate 300 are defined by a plurality of data lines 306 and scan lines 303. The pixel comprises several transmissive regions 302 and several reflective regions 304. In the embodiment, there is a raised structure 310 in the boundary between the transmissive region 302 and the reflective region 304. The raised structure 310 is used as a wall to prevent all of the polyimide in the reflective region 304 from floating to the transmissive region 302 because of the level dropping structure and the gravity. Furthermore, the photo-alignment layer can be formed evenly on the liquid crystal panel and the quality of the liquid crystal display is improved.

FIG. 3B is the cross-section view showing the lower substrate (or array substrate) 300 and an upper substrate structure 31 of the liquid crystal panel of FIG. 3A along the dotted line 312. Referring to FIG. 3B, the liquid crystal panel comprises a lower substrate structure 30 and an upper substrate structure 31. The upper substrate structure 31 comprises an upper substrate 314 and a color filter 316 facing the lower substrate structure 30. There are several blocks (not shown) on the surface of the color filter 316 facing the lower substrate structure 30. The upper substrate structure 31 also can be used in the MVA liquid crystal display. In the embodiment, a wall 324 having the fifth thickness H5 is formed on the boundary between the transmissive region 302 and the reflective region 304. The dielectric layer 322 is used to form the wall 324 by performing the exposure process and the development process with masks. The dielectric layer 322 has the fourth thickness H4 and the fourth thickness is equal to or smaller than 3 μm (micrometer). The reflective layer 320 has a sixth thickness H6. The fifth thickness H5 is equal to or larger than 1.5 μm (micrometer). It is necessary that the fifth thickness H5 is equal to or larger than the sum of the fourth thickness H4 and the sixth thickness H6, and the polyimide 340 in the reflective region 304 cannot float to the transmissive region 302. In other embodiment, the wall 324 can be formed to connect with the color filter 316, and it is used as a spacer in the liquid crystal panel. Besides, there can be a passivation layer (not shown) between the lower base 328 and the dielectric layer 322 or 318. The thickness of the dielectric layer 318 in the transmissive region 302 is smaller than the thickness of the dielectric layer 322 in the reflective region 304.

Referring to FIG. 3C, it is another embodiment of the present invention, and the structure of liquid crystal panel illustrating is similar to that of liquid crystal panel illustrating in FIG. 3B. The difference between FIG. 3B and FIG. 3C is the wall 324. In FIG. 3C, the wall 324 is in the reflective region 304, comprising part of the dielectric layer 322 and part of the reflective layer 320. In fact, the wall 324 in FIG. 3B comprises the raised structure on the boundary of the dielectric layer 322 and the raised structure on the boundary of the reflective layer 320. The wall 324 is formed in the forming process of the dielectric layer 322 and the reflective layer 320. In the process, the raised structure of the lumpy surface of the dielectric layer 322 and the reflective layer 320 are formed to the boundary of the reflective region 304, and it is connected with the transmissive region 302. There also can be a passivation layer (not shown) between the lower base 328 and the dielectric layer 322 or 318.

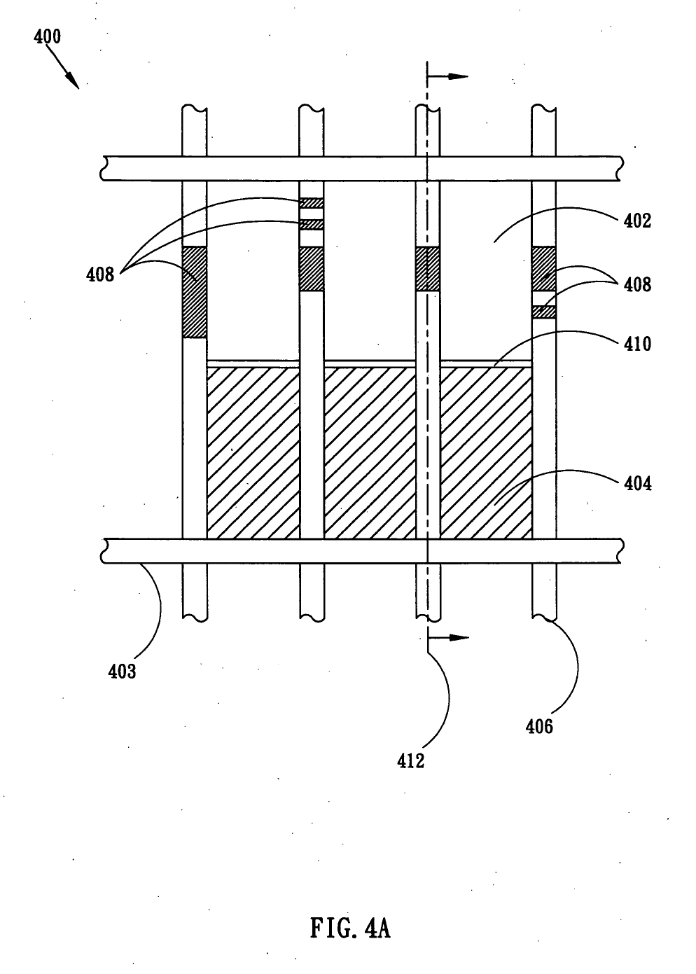

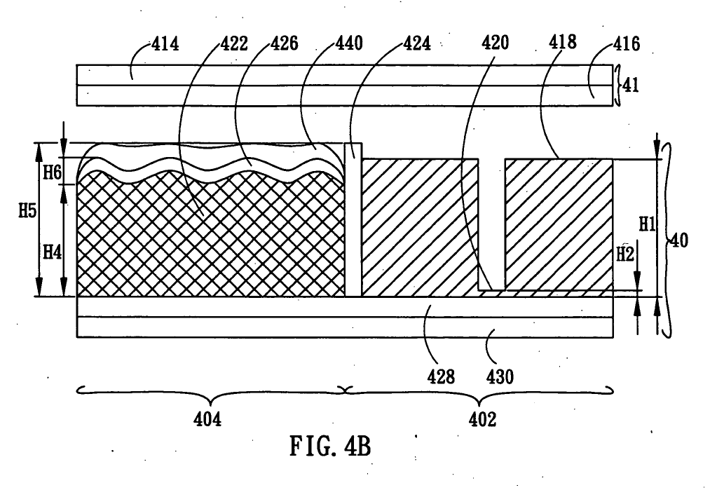

Referring to FIG. 4A, it is a plane diagram of a lower substrate (or array substrate) 400 of the liquid crystal panel in accordance with another embodiment of the present invention. A plurality of pixels on the lower substrate 400 are defined by a plurality of data lines 406 and scan lines 403. The pixel comprises several transmissive regions 402 and several reflective regions 404, and each of the transmissive regions 402 is connected with the reflective region 404 by one side. The dielectric layer on the data lines 406 in the transmissive region 402 is removed partly or completely to form a channel 408 by the exposure, development and etching process. In the present invention, there can be a plurality of channels 408 in each of the pixels. In the spirit of the present invention, the size and the length of the channels can be changed optionally, and the present invention is not limited thereto.

In the embodiment, part of the dielectric layer on the data line 406 is removed by the gray scale mask process. Therefore, the dielectric layer on the data lines has at least two different thickness. The dielectric layer in the transmissive region and in the reflective region has the first thickness H1 and the second thickness H2, respectively. Referring to FIG. 4B, the first thickness H1 and the second thickness H2 are equal to or smaller than 3 μm (micrometer), and the first thickness H1 is larger than the second thickness H2. In the embodiment, the second thickness H2 can be between 1.5 μm (micrometer) and 2.5 μm (micrometer), and it means that the dielectric layer on the data line 406 is partly removed, but not completely removed. However, it is still necessary that the first thickness H1 is larger than the second thickness H2. The dielectric layer on the data line 406 is removed to form the channel 408 between the adjacent transmissive regions. In the embodiment, the dielectric layer is partly removed, it means that the second thickness H2 is not zero and there is still a thinner dielectric layer on the bottom of the channel 408. There are a wall 410 on the boundary between the transmissive region 402 and the reflective region 404. The wall 410 is a raised structure, and the floating polyimide is restricted by the wall 410. So the polyimide cannot float from the reflective region 404 to the transmissive region because of the level-dropping structure and the gravity. In the embodiment, both of the channel 408 and the wall 410 are formed in the liquid crystal panel, and the polyimide is evenly distributed to each of the regions of the liquid crystal panel. Therefore, the photo-alignment layer is formed evenly and the liquid crystal molecules are controlled and arranged well by the even photo-alignment layer. Furthermore, the quality of the liquid crystal display is improved.

FIG. 4B is the cross-section view showing the lower substrate (or array substrate) 400 and an upper substrate structure 41 of the liquid crystal panel of FIG. 2A along the dotted line 412. The dotted line 412 is on the data line 406 and it crosses a transmissive region 402, a reflective region 404 and the region, in which the dielectric layer of the data line 406 is not removed. Referring to FIG. 4B, it comprises a lower substrate structure 40 and an upper substrate structure 41. In the embodiment, the upper substrate structure 41 comprises an upper substrate 414 and a color filter 416 facing the lower substrate structure 40. There are several blocks (not shown) on the surface of the color filter 416 facing the lower substrate structure 40. The upper substrate structure 41 also can be used in the MVA liquid crystal display. The lower substrate structure 40 comprises a lower base 430 and several data lines 428 on the lower substrate 430. The lower base 430 and the data lines 428 in the transmissive region 402 are covered by a dielectric layer 418, and the lower base 430 and the data lines 428 in the reflective region 404 are covered by the dielectric layer 422. In the transmissive region 402, the dielectric layer 418 has two different thicknesses; one is the first thickness H1 and another is the second thickness H2. In the reflective region 404, the dielectric layer 422 has the fourth thickness H4. There is a wall 424 having fifth thickness H5 on the boundary between the transmissive region 402 and the reflective region 404. In the embodiment, the wall 424 is formed in the exposure and development process applying masks. A reflective layer 426 is disposed on the dielectric layer 422 and it has the sixth thickness H6. The fourth thickness H4 is equal to or smaller than 3 μm (micrometer), and the fifth thickness H5 can be equal to or larger than 1.5 μm (micrometer). But it is necessary that the fifth thickness H5 is equal to or larger than the sum of the fourth thickness H4 and the sixth thickness H6. Therefore, the wall 424 can prevent all of the polyimide 440 in the reflective region 404 from floating to the transmissive region 402 and gathering in the transmissive region 402. Besides, there can be a passivation layer between the base 430 (or data line 428) and the dielectric layer 418 and 422.

In the spirit of the present invention, the channel 420 and the wall 424 can be applied in the transmissive liquid crystal display and the reflective liquid crystal display respectively. However, both of the channel 420 and the wall 424 can be applied in the transreflective liquid crystal display. Furthermore, both of the channel 420 and the wall 424 in the transreflective liquid crystal display with various type of the transmissive region and the reflective region. They will be shown in following embodiment.

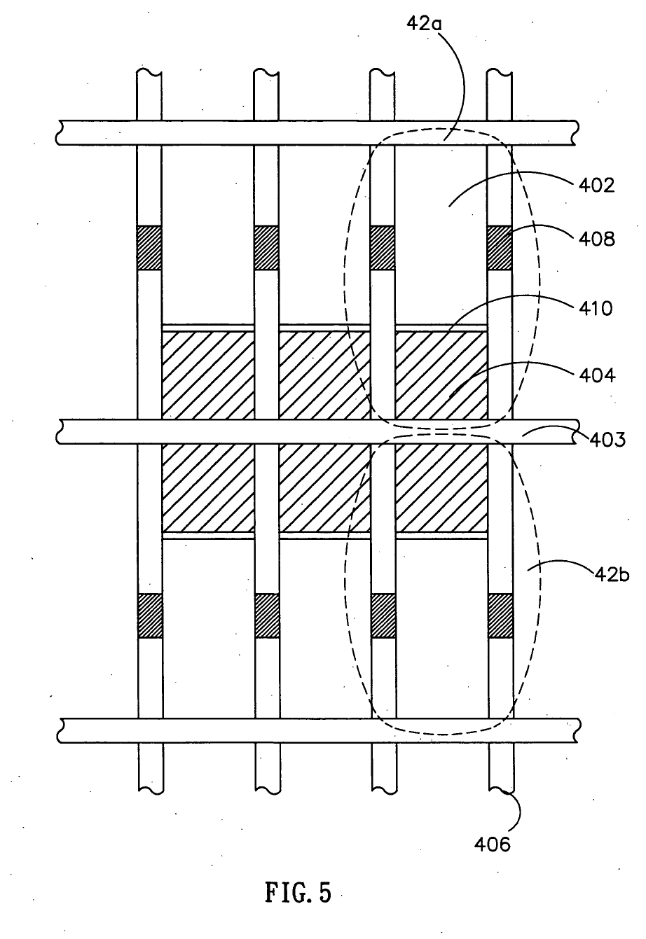

Referring to FIG. 5, it is a plane diagram of a lower substrate (or array substrate) of the liquid crystal panel in accordance with further another embodiment of the present invention. Comparing with FIG. 4A, the transmissive regions 402 and the reflective regions 404 are arranged face to face in FIG. 5. Each of the reflective regions 404 is connected with one side of the transmissive region 402 to form the first pixel 42a. The arrangement of the transmissive region 402 and the reflective region in one side of the scan line 403 is the as same as the arrangement of the transmissive region 402 and the reflective region in the first pixel 42a. However, in another side of the scan line 403 the arrangement of the transmissive region 402 and the reflective region in the first pixel 42a is turned 180° to be the second pixel 42b. Crossing another scan line 403, the arrangement of the transmissive region 402 and the reflective region in the second pixel 42b is turned 180° to form another first pixel 42a. Repeating foregoing steps, a liquid crystal panel can be formed as shown in FIG. 5. In the liquid crystal display, the arrangements of the transmissive region 402 and the reflective region 404 in each side of the scan line 403 opposite to each other. The reflective region 404 of one pixel in one side of the scan line 403 facing to the reflective region 404 of another pixel in another side of the scan line 403. The transmissive region 402 of one pixel in one side of the scan line 403 facing to the transmissive region 402 of another pixel in another side of another scan line 403. The arrangements of the transmissive region 402 and the reflective region 404 in the two side of the scan line 403 are opposite to each other. In any pixel of the liquid crystal panel, the reflective region 404 faces another reflective region 404 in another pixel, but they are separated by the scan line 403; and the transmissive region 402 faces another transmissive region 402 in further another pixel, but they are separated by another scan line 403. Therefore, it is what we said that the transmissive region 402 and reflective region 404 are arranged face to face in FIG. 5. In the embodiment, the channel 408 and the channel 410 can be formed as foregoing embodiments.

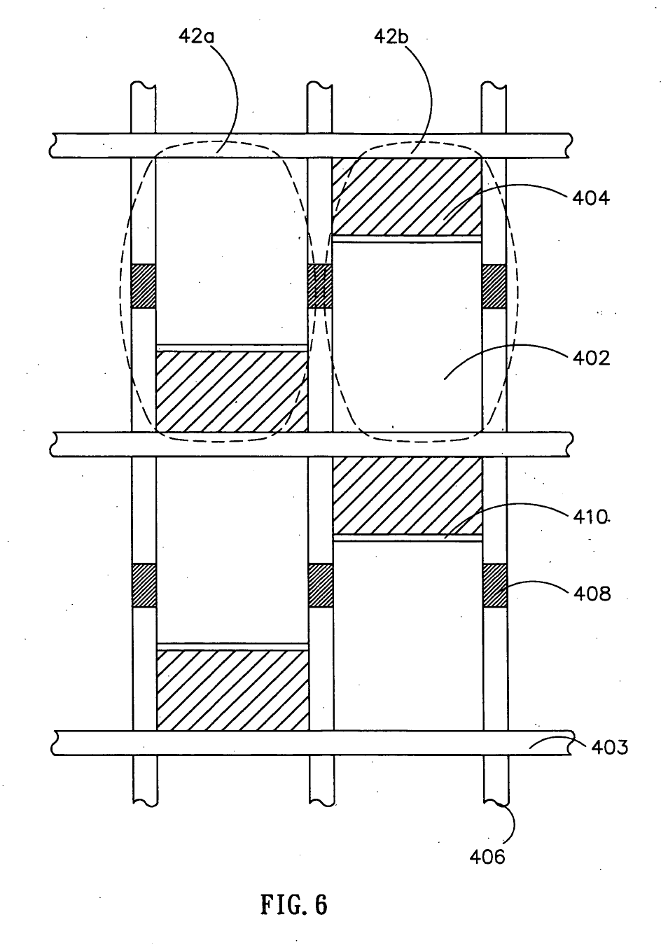

Referring to FIG. 6, it is a plane diagram of a lower substrate (or array substrate) of the liquid crystal panel in accordance with further another embodiment of the present invention. In the embodiment, the transmissive regions 402 and the reflective regions 404 are arranged in the form of S-type. In FIG. 6, each reflective region 404 is connected with one side of the transmissive region 402. The transmissive region 402 and the reflective region 404 in one side of the data line 406 opposites to the transmissive region 402 and the reflective region 404 in another side of the data line 406. In other, words, the arrangement of the transmissive region 402 and the reflective region 404 in one side of the data line 406 is turned 180° to form that of the transmissive region 402 and the reflective region 404 in another side of the data line 406. The arrangements of the transmissive region 402 and the reflective region 404 in both of the two side of the scan line 403 are the same. In the embodiment, the channel 408 and the channel 410 can be formed as foregoing embodiments.

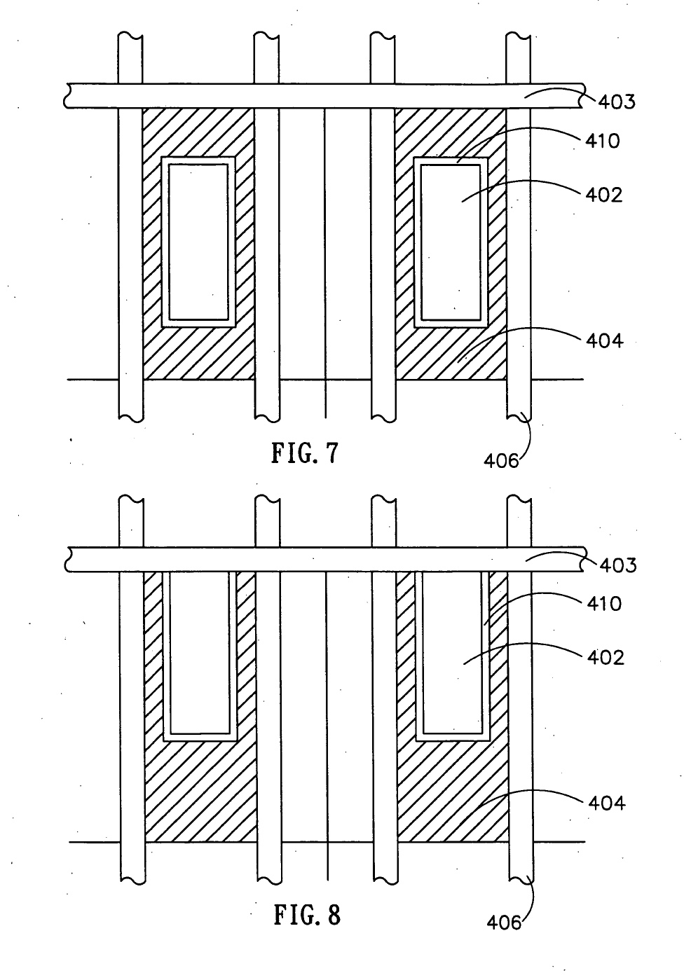

Referring to FIG. 7, it is a plane diagram of a lower substrate (or array substrate) of the liquid crystal panel in accordance with further another embodiment of the present invention. In the embodiment, each transmissive region 402 is surrounded by one reflective region 404. In other words, all sides of the transmissive region 402 are connected with the same reflective region 404. There is a wall 410 on the boundary between the transmissive region 402 and the reflective region 404.

Referring to FIG. 8, it is a plane diagram of a lower substrate (or array substrate) of the liquid crystal panel in accordance with further another embodiment of the present invention. In the embodiment, the arrangement of the transmissive region 402 and the reflective region 404 is similar to the arrangement of the transmissive region 402 and the reflective region 404 illustrated in FIG. 7. In FIG. 8 the transmissive region 402 is completely surrounded by the reflective region 404, and at least one side of the transmissive region 402 is not connected with the reflective region 404. There is a wall 410 on the boundary between the transmissive region 402 and the reflective region 404.

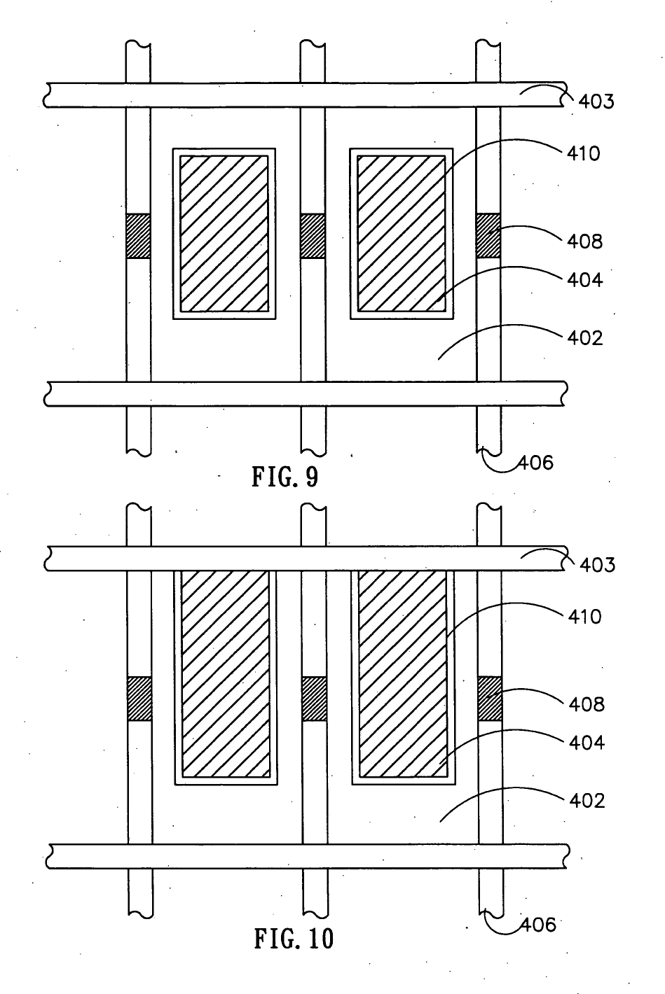

Referring to FIG. 9, it is a plane diagram of a lower substrate (or array substrate) of the liquid crystal panel in accordance with further another embodiment of the present invention. In the embodiment, each reflective region 404 is surrounded by one transmissive region 402. In other words, all sides of the reflective region 404 are connected with the same transmissive region 402. There are channels 408 on the data lines 406 between the adjacent transmissive regions 402, and there are wall 410 on the boundary between the transmissive regions 402 and the reflective regions 404.

Referring to FIG. 10, it is a plane diagram of a lower substrate (or array substrate) of the liquid crystal panel in accordance with further another embodiment of the present invention. In the embodiment, the arrangement of the transmissive region 402 and the reflective region 404 is similar to the arrangement of the transmissive region 402 and the reflective region 404 illustrated in FIG. 9. But in FIG. 10 the reflective region 404 is completely surrounded by the transmissive region 402, and at least one side of the reflective region 404 is not connected with the transmissive region 404. There is a wall 410 on the boundary between the transmissive region 402 and the reflective region 404. There are channels 408 on the data lines 406 between the adjacent transmissive regions 402, and there are wall 410 on the boundary between the transmissive regions 402 and the reflective regions 404.

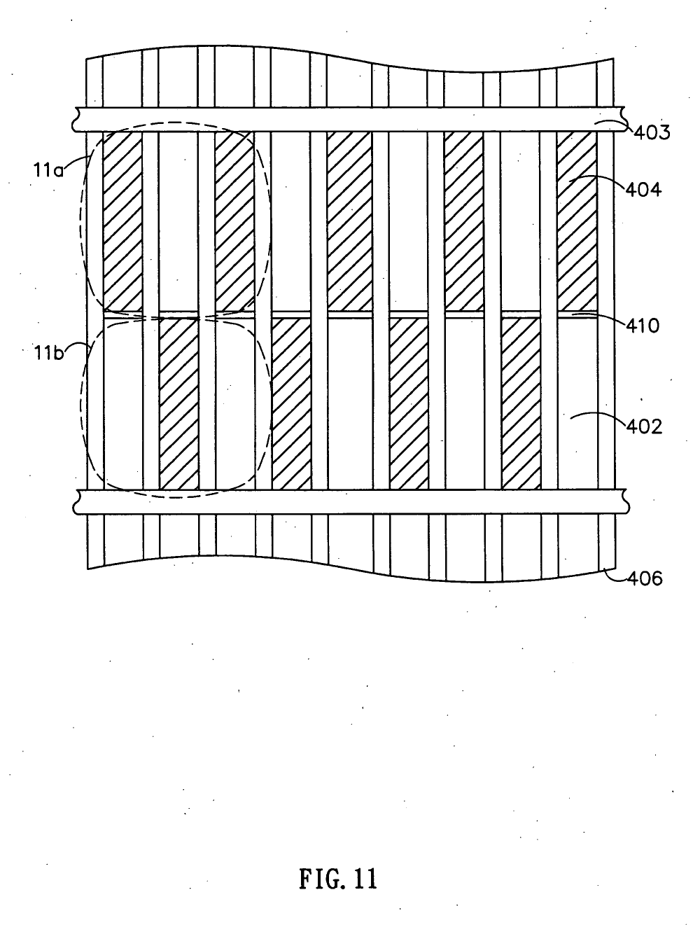

Referring to FIG. 11, it is a plane diagram of a lower substrate (or array substrate) of the liquid crystal panel in accordance with further another embodiment of the present invention. In the embodiment, a transmissive region 402 is between two reflective regions 404 to form the unit 11a as a sandwich, and a reflective region 404 is between two transmissive regions 402 to form the unit 11b. In the unit 11a and the unit 11b, there is a data line 406 between each transmissive region 402 and each reflective region 404. In both two sides of the scan line 403, the unit 11a and the unit 11b are interlocked and arranged. The arrangement of the unit 11a and the unit 11b in one side of the scan line 403 is opposite to that of the unit 11a and the unit 11b in another side of the scan line 403. There are the wall 410 on the boundary between the transmissive regions 402 and the reflective regions 404.

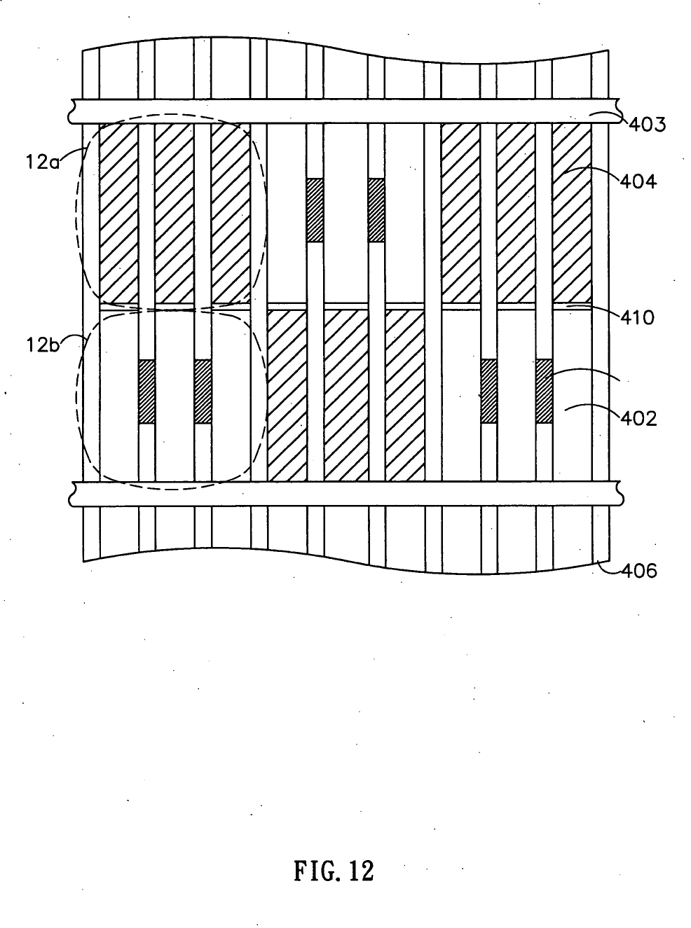

Referring to FIG. 12, it is a plane diagram of a lower substrate (or array substrate) of the liquid crystal panel in accordance with further another embodiment of the present invention. In the embodiment, three reflective regions 404 are combined to be a first unit 12a and there is a data line 406 between the two adjacent reflective regions 404. Three reflective regions 404 are combined to be a second unit 12a and there is a data line 406 between the two adjacent reflective regions 404. At both two sides of the scan line 403, the first unit 12a and the second unit 12b are interlocked and arranged. The arrangement of the first unit 12a and the second unit 12b in one side of the scan line 403 is opposite to that of the first unit 12a and the second unit 12b at another side of the scan line 403. There are channels 408 on the data lines 406 between the adjacent transmissive regions 402, and there are wall 410 on the boundary between the transmissive regions 402 and the reflective regions 404.

In the single cell gap liquid crystal panel, the base and the conductive lines in the transmissive region is covered by a dielectric layer having at least two different thicknesses. In the dual cell gap liquid crystal panel, the dielectric layer on the base in the transmissive region is removed but the on the conductive lines. Although the liquid crystal panels of the foregoing embodiments are dual cell gap type liquid crystal panel, the present invention is not limited. In spirit of the present invention, the liquid crystal panel of the present invention can be used in each type of transmissive liquid crystal panel, reflective liquid crystal panel, single cell gap liquid crystal panel, dual cell gap liquid crystal panel, and transreflective liquid crystal panel.

The foregoing embodiments are the preferred embodiments, but not limited. In the spirit of the present invention, the package structure can be modified and implemented, and the variations are still part of the present invention. Therefore, the scope of the present invention is defined by the claims.

What is claimed is:

1. An array substrate for a liquid crystal display, comprising:
a base;
a plurality of data lines disposed on said base;
a plurality of scan lines, disposed on said base, defining a plurality of pixels with said plurality of data lines; and
a dielectric layer disposed on said base to cover parts of said plurality of data lines, wherein said dielectric layer, on said plurality of data lines between adjacent said pixels, has a first thickness and a second thickness smaller than said second thickness.

2. The array substrate according to claim 1, wherein at least one of said plurality of pixels has a transmissive region and a reflective region, said dielectric layer between two adjacent transmissive regions has said first thickness and said second thickness, said dielectric layer in said transmissive region has a third thickness, and said second thickness is equal to or larger than said third thickness.

3. The array substrate according to claim 2, wherein said third thickness is about zero.

4. The array substrate according to claim 2, wherein said dielectric layer in said reflective region has a fourth thickness, and said dielectric layer on a boundary between said transmissive region and said reflective region has a fifth thickness, wherein said fifth thickness is equal to or larger than said fourth thickness, and said fourth thickness is larger than said third thickness.

5. The array substrate according to claim 4, further comprising a reflective layer covering said dielectric layer in said reflective region, wherein said dielectric layer covered by said reflective layer has a sixth thickness, wherein said fifth thickness is equal to or larger than the sum of said fourth thickness and said sixth thickness.

6. The array substrate according to claim 4, wherein said fourth thickness is equal to or smaller than 3 micrometer.

7. The array substrate according to claim 4, wherein said fifth thickness is equal to or larger than 1.5 micrometer.

8. The array substrate according to claim 1, wherein said first thickness is equal to or smaller than 3 micrometer.

9. The array substrate according to claim 8, wherein said second thickness is equal to or smaller than 3 micrometer.

10. The array substrate according to claim 8, wherein said second thickness is between 1.5 micrometer and 2.5 micrometer.

11. A method for manufacturing an array substrate, comprising:
forming a plurality of scan lines on a base;
forming a plurality of data lines on said base to define a plurality of pixels with said plurality of scan lines; and
forming a dielectric layer on said base to cover parts of said plurality of data lines, wherein said dielectric layer, on said data lines between each two adjacent said pixel, has a first thickness and a second thickness smaller than said first thickness.

12. The method according to claim 11, wherein said first thickness is equal to or smaller than 3 micrometer.

13. The method according to claim 12, wherein said second thickness is equal to or smaller than 3 micrometer.

14. The method according to claim 12, wherein said second thickness is between 1.5 micrometer and 2.5 micrometer.

15. The method according to claim 11, further comprising defining a transmissive region and a reflective region in said pixel, wherein said step of forming the dielectric layer on said base to cover said plurality of data lines comprises:
forming said dielectric layer on said base to cover said plurality of data lines and said plurality of pixels; and
removing parts of said dielectric layer, so that said dielectric layer on said data line between each two adjacent said pixels has said first thickness and said second thickness, and said dielectric layer in said transmissive region has a third thickness equal to or smaller than said second thickness.

16. The method according to claim 15, wherein said third thickness is about zero.

17. The method according to claim 15, wherein said step of forming the dielectric layer on said base to cover said plurality of data lines further comprises:
removing parts of said dielectric layer, so that said dielectric layer has a fourth thickness in said reflective region and has a fifth thickness on a boundary between said transmissive region and said reflective region, wherein said fifth thickness is equal to or larger than said fourth thickness, said forth thickness is equal to or larger than said third thickness; and
forming a reflective layer covering said dielectric layer, wherein said dielectric layer covered by the reflective layer has a sixth thickness equal to or larger than the sum of said fourth thickness and said sixth thickness.

18. The method according to claim 17, wherein said fourth thickness is equal to or smaller than 3 micrometer.

19. The method according to claim 17, wherein said fifth thickness is equal to or larger than 1.5 micrometer.

20. The method according to claim 11, wherein said step of forming the dielectric layer on said base to cover said plurality of data lines is accomplished by a gray scale mask process.
